(19) United States
(12) Patent Application Publication
(10) Pub. No.: US 2026/0246376 A1
(43) Pub. Date: Aug. 20, 2026

(54) RESONANT CONVERTER

(71) Applicant: LITE-ON Technology Corporation, Taipei (TW)

(72) Inventors: Bo-Ruei CIOU, Taipei (TW); Cheng-Wei TSENG, Taipei (TW); Chen CHEN, Taipei (TW)

(21) Appl. No.: 19/260,637

(22) Filed: Jul. 7, 2025

Related U.S. Application Data
(60) Provisional application No. 63/758,368, filed on Feb. 14, 2025.

(30) Foreign Application Priority Data
May 16, 2025 (CN) 2025209646997

(51) Int. Cl. H02M 3/00; H02M 1/00; H02M 1/38; H02M 3/335

(52) U.S. Cl. CPC H02M 3/01; H02M 1/0058; H02M 1/385; H02M 3/33571

(57) ABSTRACT

A resonant converter includes an input circuit, a primary switching circuit, a resonant circuit, a transformer circuit, a secondary switching circuit and an output circuit. Each transformer of the transformer circuit includes a primary winding and a secondary winding. The primary windings are coupled to each other in a Wye connection, and the secondary windings are coupled to each other in a delta connection. The secondary switching circuit is coupled to the transformer circuit and includes a plurality of input nodes. The plurality of input nodes are coupled to the secondary windings of the transformer circuit in a Wye connection. The configuration of the resonant tanks and transformers may reduce a core loss and have a better current balance effect. Thereby, the overall loss of the power circuit may be reduced.

### CROSS REFERENCE TO RELATED APPLICATION

This application claims the priority benefit of U.S. provisional patent application No. 63/758,368, filed Feb. 14, 2025, and Chinese Patent Application Serial Number 2025209646997, filed on May 16, 2025, the full disclosure of which is incorporated herein by reference.

### BACKGROUND

### Technical Field

The present disclosure is related to a power converter. More particularly, the embodiments are related to a resonant converter.

### Related Art

In low-voltage and high-current application scenarios such as charging piles, energy storage systems, and artificial intelligence servers, a three-phase interleaved topology is commonly employed in power circuits to distribute current stress. The power circuits basically include magnetic components such as transformers and inductors, and the magnetic components are affected by magnetic fields and produce losses. In addition, when characteristic deviations exist among circuit components, a phase current imbalance may occur, which also leads to an increase in the overall loss of the power circuit.

Therefore, it is desirable to effectively reduce the overall loss of the power circuit.

### SUMMARY

The embodiment of the present disclosure provides a resonant converter which may have a better current balance effect and reduced core loss. Thus, the overall loss of the power circuit may be reduced.

In order to achieve the above object and other related objects, the present disclosure provides a resonant converter including an input circuit, a primary switching circuit, a resonant circuit, a transformer circuit, a secondary switching circuit and an output circuit. The input circuit is configured to provide an input voltage. The primary switching circuit is coupled to the input circuit and includes a plurality of output nodes. The resonant circuit is electrically connected to the primary switching circuit and includes a plurality of resonant tanks. The plurality of resonant tanks includes a plurality of resonant inductors. The transformer circuit is coupled to the resonant circuit. The transformer circuit has a plurality of transformers. Each of the plurality of transformers includes a primary winding and a secondary winding. The plurality of primary windings include an input terminal and an output terminal. The plurality of primary windings are coupled to each other in a Wye connection, and the plurality of secondary windings are coupled to each other in a delta connection. The secondary switching circuit is coupled to the transformer circuit. The secondary switching circuit includes a plurality of input nodes. The plurality of input nodes are coupled to the plurality of secondary windings of the transformer circuit in the Wye connection. The output circuit is coupled to the secondary switching circuit and generates an output voltage.

According to the above, the resonant converter of the present disclosure may reduce the core loss through the configuration of the plurality of resonant tanks and transformers and may have a better current balancing effect when there are characteristic errors in circuit elements. Thereby, the effect of reducing the overall loss of the power circuit is achieved.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows in conjunction with the accompanying drawings, in which:

FIG. 1 is a schematic diagram of a power supply circuit according to an embodiment of the present disclosure.

FIG. 2 is a schematic diagram of a first embodiment of a resonant converter according to an embodiment of the present disclosure.

FIG. 3 is a schematic diagram of a second embodiment of a resonant converter according to an embodiment of the present disclosure.

FIG. 4 is a schematic diagram of a third embodiment of a resonant converter according to an embodiment of the present disclosure.

FIG. 5 is a schematic diagram of a fourth embodiment of a resonant converter according to an embodiment of the present disclosure.

FIG. 6 is a schematic diagram of a first embodiment of a control signal according to an embodiment of the present disclosure.

FIG. 7 is a schematic diagram of an embodiment of a dead time according to an embodiment of the present disclosure.

FIG. 8 is a schematic diagram of a second embodiment of a control signal according to an embodiment of the present disclosure.

FIG. 9A is a first comparative diagram of three-phase current errors according to an embodiment of the present disclosure.

FIG. 9B is a second comparative diagram of three-phase current errors according to an embodiment of the present disclosure.

FIG. 9C is a third comparative diagram of three-phase current errors according to an embodiment of the present disclosure.

FIG. 10A is a first schematic diagram of an integrated magnetic core module according to an embodiment of the present disclosure.

FIG. 10B is a second schematic diagram of an integrated magnetic core module according to an embodiment of the present disclosure.

FIG. 10C is a third schematic diagram of an integrated magnetic core module according to an embodiment of the present disclosure.

FIG. 10D is a fourth schematic diagram of an integrated magnetic core module according to an embodiment of the present disclosure.

FIG. 11 is a first schematic diagram of an arrangement of a transformer and a resonant inductor according to an embodiment of the present disclosure.

FIG. 12 is a second schematic diagram of an arrangement of a transformer and a resonant inductor according to an embodiment of the present disclosure.

FIG. 13 is a third schematic diagram of an arrangement of a transformer and a resonant inductor according to an embodiment of the present disclosure.

### DETAILED DESCRIPTION OF THE EMBODIMENTS

The present invention will be described more fully hereinafter with reference to the accompanying drawings, in which exemplary embodiments of the invention are shown. This present invention may, however, be embodied in many different forms and should not be construed as limited to the embodiments set forth herein. Rather, these embodiments are provided so that the description of the present invention will be thorough and complete and will fully convey the scope of the present invention to those skilled in the art.

Certain terms are used throughout the description and following claims to refer to particular components. As one skilled in the art will appreciate, manufacturers may refer to a component by different names. This document does not intend to distinguish between components that differ in name but not in function. In the following description and in the claims, the terms “include/including” and “comprise/comprising” are used in an open-ended fashion and thus should be interpreted as “including but not limited to”. “Substantial/substantially” means that, within an acceptable error range, a person skilled in the art may solve the technical problem in a certain error range to achieve the basic technical effect.

The following description is of the best-contemplated mode of carrying out the invention. This description is provided for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that comprises a series of elements not only includes these elements but also comprises other elements not specified expressly, or may include inherent elements of the process, method, object, or device. If no more limitations are made, an element limited by “include a/an . . . ” does not exclude other same elements existing in the process, the method, the article, or the device which comprises the element.

In the following embodiment, the same reference numerals are used to refer to the same or similar elements throughout the invention.

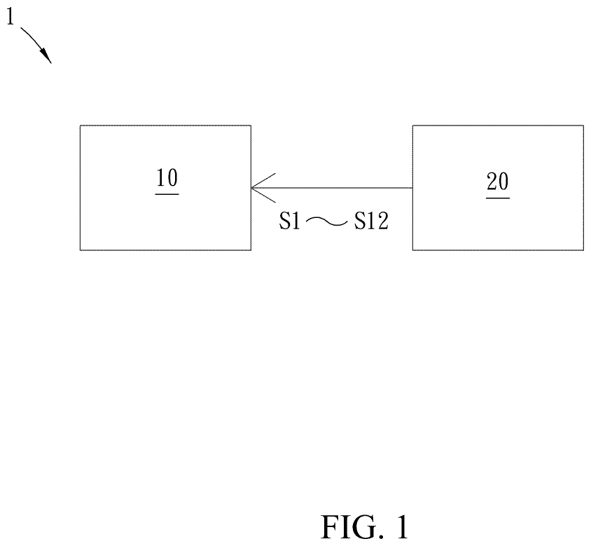

Please refer to FIG. 1, which is a schematic diagram of a power supply circuit according to an embodiment of the present disclosure. The power supply circuit 1 may at least include a resonant converter 10 and a control circuit 20. The resonant converter 10 is electrically connected to the control circuit 20. The resonant converter 10 may be a DC-to-DC converter for outputting a DC voltage to an electrically connected load or circuit. For example, the resonant converter 10 may be used to output a DC voltage to a voltage regulator (VR) circuit. The control circuit 20 is configured to provide control signals required for the resonant converter 10 to operate, such as control signals S1 to S12. The control circuit 20 is, for example, a microcontroller, and the present disclosure is not limited thereto.

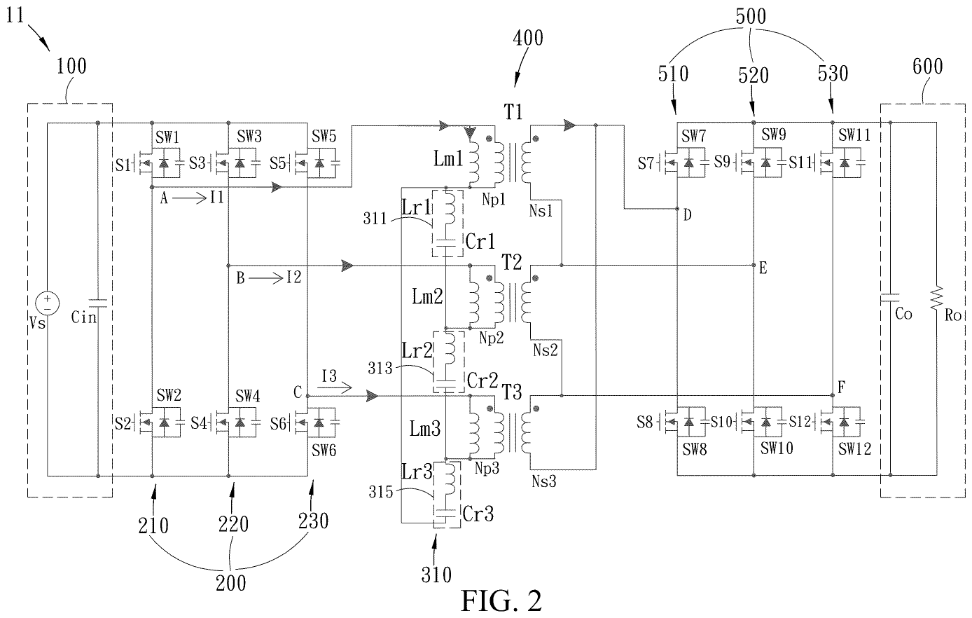

Please refer to FIG. 2, which is a schematic diagram of a first embodiment of a resonant converter according to an embodiment of the present disclosure. The resonant converter 11 includes an input circuit 100, a primary switching circuit 200, a resonant circuit 310, a transformer circuit 400, a secondary switching circuit 500, and an output circuit 600. The transformer circuit 400 includes a first transformer T1, a second transformer T2, and a third transformer T3. The secondary switching circuit 500 includes a first input node D, a second input node E, and a third input node F.

The input circuit 100 includes a voltage source Vs and an input capacitor Cin. The voltage source Vs provides an input voltage. Two terminals of the input capacitor Cin are respectively coupled to the voltage source Vs; that is, the input capacitor Cin and the voltage source Vs are coupled in parallel.

The primary switching circuit 200 is coupled to the input circuit 100. The primary switching circuit 200 includes a first bridge arm 210, a second bridge arm 220, and a third bridge arm 230. The first bridge arm 210, the second bridge arm 220, and the third bridge arm 230 are coupled to each other in parallel. The first bridge arm 210 includes a first switching unit SW1 and a second switching unit SW2 connected in series, and a first output node A is located between the first switching unit SW1 and the second switching unit SW2. A first terminal of the first switching unit SW1 is coupled to a first terminal of the input capacitor Cin, a second terminal of the first switching unit SW1 is coupled to the first output node A, and a control terminal of the first switching unit SW1 receives the control signal S1. A first terminal of the second switching unit SW2 is coupled to the first output node A, a second terminal of the second switching unit SW2 is coupled to a second terminal of the input capacitor Cin, and a control terminal of the second switching unit SW2 receives the control signal S2. The second bridge arm 220 includes a third switching unit SW3 and a fourth switching unit SW4 connected in series, and a second output node output node B is located between the third switching unit SW3 and the fourth switching unit SW4. A first terminal of the third switching unit SW3 is coupled to the first terminal of the input capacitor Cin, a second terminal of the third switching unit SW3 is coupled to the second output node B, and a control terminal of the third switching unit SW3 receives the control signal S3. A first terminal of the fourth switching unit SW4 is coupled to the second output node B, a second terminal of the fourth switching unit SW4 is coupled to the second terminal of the input capacitor Cin, and a control terminal of the fourth switching unit SW4 receives the control signal S4. The third bridge arm 230 includes a fifth switching unit SW5 and a sixth switching unit SW6 connected in series, and a third output node C is located between the fifth switching unit SW5 and the sixth switching unit SW6. A first terminal of the fifth switching unit SW5 is coupled to the first terminal of the input capacitor Cin, a second terminal of the fifth switching unit SW5 is coupled to the third output node C, and a control terminal of the fifth switching unit SW5 receives the control signal S5. A first terminal of the sixth switching unit SW6 is coupled to the third output node C, a second terminal of the sixth switching unit SW6 is coupled to the second terminal of the input capacitor Cin, and a control terminal of the sixth switching unit SW6 receives the control signal S6.

The resonant circuit 310 includes a plurality of resonant tanks. Each of the plurality of resonant tanks includes a resonant capacitor and a resonant inductor. The resonant circuit 310 includes a first resonant tank 311, a second resonant tank 313, and a third resonant tank 315. The first resonant tank 311 includes a first resonant inductor Lr1 and a first resonant capacitor Cr1. A first terminal of the first resonant inductor Lr1 is coupled to the first transformer T1, and a second terminal of the first resonant inductor Lr1 is coupled to a first terminal of the first resonant capacitor Cr1. A second terminal of the first resonant capacitor Cr1 is coupled to the second transformer T2. The second resonant tank 313 includes a second resonant inductor Lr2 and a second resonant capacitor Cr2. A first terminal of the second resonant inductor Lr2 is coupled to the second transformer T2, and a second terminal of the second resonant inductor Lr2 is coupled to a first terminal of the second resonant capacitor Cr2. The second terminal of the second resonant capacitor Cr2 is coupled to the third transformer T3. The third resonant tank 315 includes a third resonant inductor Lr3 and a third resonant capacitor Cr3. A first terminal of the third resonant inductor Lr3 is coupled to the third transformer T3, and a second terminal of the third resonant inductor Lr3 is coupled to a first terminal of the third resonant capacitor Cr3. A second terminal of the third resonant capacitor Cr3 is coupled to the first transformer T1. In this embodiment, the first resonant inductor Lr1, the second resonant inductor Lr2, the third resonant inductor Lr3, the first resonant capacitor Cr1, the second resonant capacitor Cr2 and the third resonant capacitor Cr3 are coupled to a primary of the transformer circuit 400 in a delta connection.

The first transformer T1 has a primary winding Np1, a secondary winding Ns1 and a magnetizing inductor Lm1. An input terminal of the primary winding Np1 is coupled to the first output node A, and an output terminal of the primary winding Np1 is coupled to the first terminal of the first resonant inductor Lr1. The magnetizing inductor Lm1 is coupled between the input terminal and the output terminal of the primary winding Np1. An output terminal of the secondary winding Ns1 is coupled to the first input node D, and an input terminal of the secondary winding Ns1 is coupled to the second input node E. The second transformer T2 has a primary winding Np2, a secondary winding Ns2 and a magnetizing inductor Lm2. An input terminal of the primary winding Np2 is coupled to the second output node B, and an output terminal of the primary winding Np2 is coupled to the second terminal of the first resonant capacitor Cr1 and the first terminal of the second resonant inductor Lr2. The magnetizing inductor Lm2 is coupled between the input terminal and the output terminal of the primary winding Np2. An output terminal of the secondary winding Ns2 is coupled to the second input node E, and an input terminal of the secondary winding Ns2 is coupled to the third input node F. The third transformer T3 has a primary winding Np3, a secondary winding Ns3 and a magnetizing inductor Lm3. An input terminal of the primary winding Np3 is coupled to the third output node C, and the output terminal of the primary winding Np3 is coupled to the second terminal of the second resonant capacitor Cr2 and the first terminal of the third resonant inductor Lr3. The magnetizing inductor Lm3 is coupled between the input terminal and the output terminal of the primary winding Np3. An output terminal of the secondary winding Ns3 is coupled to the third input node F of the secondary switching circuit 500, and an input terminal of the secondary winding Ns3 is coupled to the first input node D. In this embodiment, the primary winding Np1 of the first transformer T1, the primary winding Np2 of the second transformer T2, and the primary winding Np3 of the third transformer T3 are coupled to each other in a Wye connection. The secondary winding Ns1 of the first transformer T1, the secondary winding Ns2 of the second transformer T2, and the secondary winding Ns3 of the third transformer T3 are coupled to each other in a delta connection.

The secondary switching circuit 500 includes a first rectification unit 510, a second rectification unit 520 and a third rectification unit 530. The first rectification unit 510, the second rectification unit 520 and the third rectification unit 530 are coupled to each other in parallel. The first rectification unit 510 includes a seventh switching unit SW7 and an eighth switching unit SW8 connected in series. The first input node D is located between the seventh switching unit SW7 and the eighth switching unit SW8. A first terminal of the seventh switching unit SW7 is coupled to the output circuit 600, a second terminal of the seventh switching unit SW7 is coupled to the first input node D, and a control terminal of the seventh switching unit SW7 receives the control signal S7. A first terminal of the eighth switching unit SW8 is coupled to the first input node D, a second terminal of the eighth switching unit SW8 is coupled to the output circuit 600, and a control terminal of the eighth switching unit SW8 receives the control signal S8. The second rectification unit 520 includes a ninth switching unit SW9 and a tenth switching unit SW10 connected in series. The second input node E is located between the ninth switching unit SW9 and the tenth switching unit SW10. A first terminal of the ninth switching unit SW9 is coupled to the output circuit 600, a second terminal of the ninth switching unit SW9 is coupled to the second input node E, and a control terminal of the ninth switching unit SW9 receives the control signal S9. A first terminal of the tenth switching unit SW10 is coupled to the second input node E, a second terminal of the tenth switching unit SW10 is coupled to the output circuit 600, and a control terminal of the tenth switching unit SW10 receives the control signal S10. The third rectification unit 530 includes an eleventh switching circuit SW11 and a twelfth switching circuit SW12 connected in series. The third input node F is located between the eleventh switching circuit SW11 and the twelfth switching circuit SW12. A first terminal of the eleventh switching circuit SW11 is coupled to the output circuit output circuit 600, a second terminal of the eleventh switching circuit SW11 is coupled to the third input node F, and a control terminal of the eleventh switching circuit SW11 receives the control signal S11. A first terminal of the twelfth switching circuit SW12 is coupled to the third input node F, a second terminal of the twelfth switching circuit SW12 is coupled to the output circuit 600, and a control terminal of the twelfth switching circuit SW12 receives the control signal S12. In this embodiment, the first input node D, the second input node E and the third input node F are coupled to a secondary of the transformer circuit 400 in a Wye connection.

In one embodiment, the first switching unit SW1 to the twelfth switching unit SW12 may be a metal-oxide-semiconductor field-effect transistor (MOSFET), a trench MOSFET or an insulated gate bipolar transistor (IGBT), and the present disclosure is not limited thereto.

The output circuit 600 is coupled to the secondary switching circuit 500 and includes an output capacitor Co and an output resistor Ro connected in parallel. The first terminals of the output capacitor Co and the output resistor Ro are coupled to the first terminals of the seventh switching unit SW7, the ninth switching unit SW9, and the eleventh switching unit SW11. The second terminals of the output capacitor Co and the output resistor Ro are coupled to the second terminals of the eighth switching unit SW8, the tenth switching unit SW10, and the twelfth switching unit SW12. The output circuit 600 is configured to generate an output voltage to a coupled load.

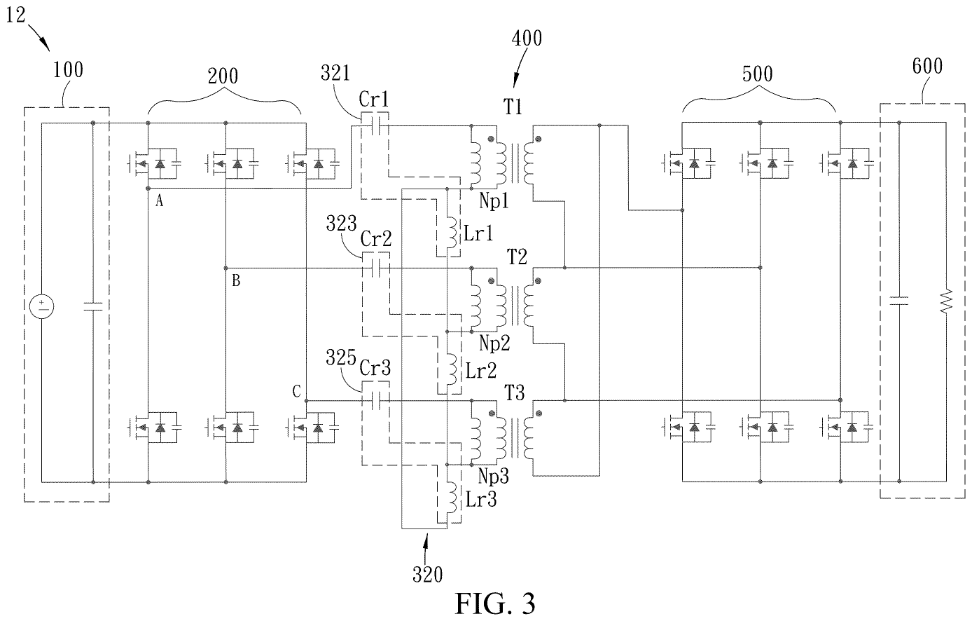

Please refer to FIG. 3, which is a schematic diagram of a second embodiment of a resonant converter according to an embodiment of the present disclosure. In FIG. 2 and FIG. 3, elements with the same reference numerals have the same functions and thus will not be described in detail herein. The difference between FIG. 3 and FIG. 2 is that a resonant converter 12 includes the input circuit 100, the primary switching circuit 200, a resonant circuit 320, the transformer circuit 400, the secondary switching circuit 500, and the output circuit 600. The resonant circuit 320 includes a first resonant tank 321, a second resonant tank 323, and a third resonant tank 325. The first resonant tank 321 includes a first resonant inductor Lr1 and a first resonant capacitor Cr1. A first terminal of the first resonant inductor Lr1 is coupled to the output terminal of the primary winding Np1, and a second terminal of the first resonant inductor Lr1 is coupled to the output terminal of the primary winding Np2. A first terminal of the first resonant capacitor Cr1 is coupled to the first output node A, and a second terminal of the first resonant capacitor Cr1 is coupled to the input terminal of the primary winding Np1. The second resonant tank 323 includes a second resonant inductor Lr2 and a second resonant capacitor Cr2. A first terminal of the second resonant inductor Lr2 is coupled to the output terminal of the primary winding Np2, and a second terminal of the second resonant inductor Lr2 is coupled to the output terminal of the primary winding Np3. A first terminal of the second resonant capacitor Cr2 is coupled to the second output node B, and a second terminal of the second resonant capacitor Cr2 is coupled to the input terminal of the primary winding Np2. The third resonant tank 325 includes a third resonant inductor Lr3 and a third resonant capacitor Cr3. A first terminal of the third resonant inductor Lr3 is coupled to the output terminal of the primary winding Np3, and a second terminal of the third resonant inductor Lr3 is coupled to the output terminal of the primary winding Np1. A first terminal of the third resonant capacitor Cr3 is coupled to the third output node C, and a second terminal of the third resonant capacitor Cr3 is coupled to the input terminal of the primary winding Np3. In this embodiment, the output terminal of the primary winding Np1, the output terminal of the primary winding Np2, the output terminal of the primary winding Np3, the first resonant inductor Lr1, the second resonant inductor Lr2 and the third resonant inductor Lr3 are coupled to each other in a delta connection.

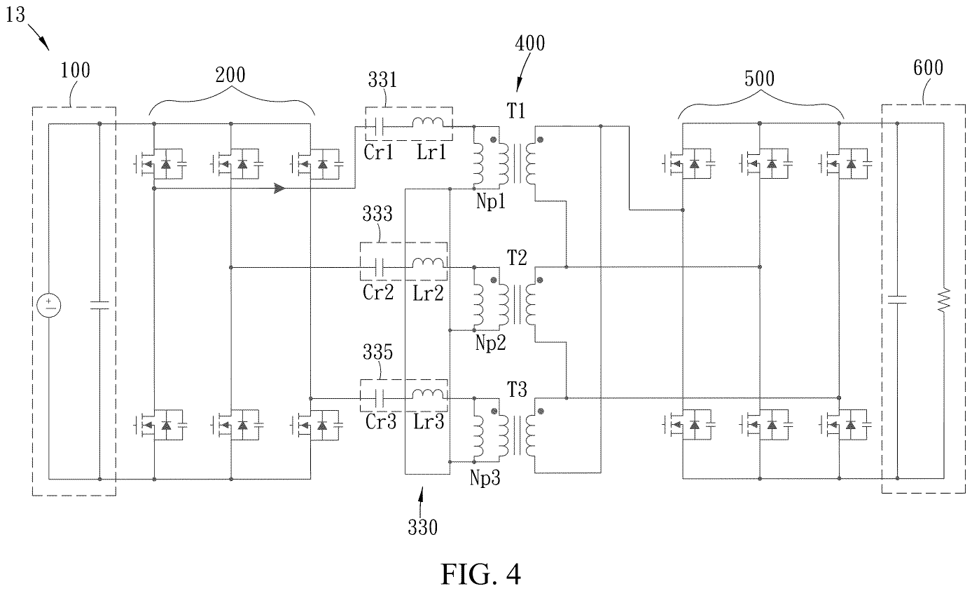

Please refer to FIG. 4, which is a schematic diagram of a third embodiment of a resonant converter according to an embodiment of the present disclosure. In FIG. 3 and FIG. 4, elements with the same reference numerals have the same functions and thus are not described in detail herein. The difference between FIG. 4 and FIG. 3 is that the resonant converter 13 includes the input circuit 100, the primary switching circuit 200, a resonant circuit 330, the transformer circuit 400, the secondary switching circuit 500, and the output circuit 600. The resonant circuit 330 includes a first resonant tank 331, a second resonant tank 333, and a third resonant tank 335. In this embodiment, the first terminal of the first resonant inductor Lr1 is coupled to the second terminal of the first resonant capacitor Cr1, and the second terminal of the first resonant inductor Lr1 is coupled to the input terminal of the primary winding Np1. The first terminal of the second resonant inductor Lr2 is coupled to the second terminal of the second resonant capacitor Cr2, and the second terminal of the second resonant inductor Lr2 is coupled to the input terminal of the primary winding Np2. The first terminal of the third resonant inductor Lr3 is coupled to the second terminal of the third resonant capacitor Cr3, and the second terminal of the third resonant inductor Lr3 is coupled to the input terminal of the primary winding Np3. In this embodiment, the first resonant capacitor Cr1, the second resonant capacitor Cr2, the third resonant capacitor Cr3, the first resonant inductor Lr1, the second resonant inductor Lr2 and the third resonant inductor Lr3 are coupled to the primary winding Np1, the primary winding Np2 and the primary winding Np3 in a Wye connection, and the primary winding Np1, the primary winding Np2, and the primary winding Np3 are coupled to each other in a Wye connection.

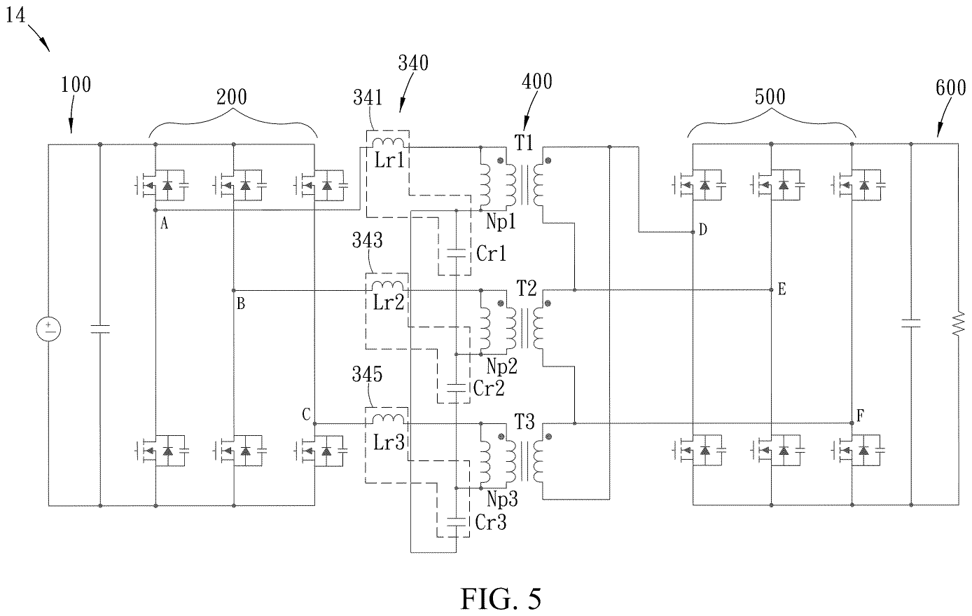

Please refer to FIG. 5, which is a schematic diagram of a fourth embodiment of a resonant converter according to an embodiment of the present disclosure. In FIG. 2 and FIG. 5, elements with the same reference numerals have the same functions and thus will not be described in detail herein. The difference between FIG. 5 and FIG. 2 is that the resonant converter 14 includes the input circuit 100, the primary switching circuit 200, a resonant circuit 340, the transformer circuit 400, the secondary switching circuit 500, and the output circuit 600. The resonant circuit 340 includes a first resonant tank 341, a second resonant tank 343, and a third resonant tank 345. The first resonant tank 341 includes a first resonant inductor Lr1 and a first resonant capacitor Cr1. A first terminal of the first resonant inductor Lr1 is coupled to the first output node A, and a second terminal of the first resonant inductor Lr1 is coupled to the input terminal of the primary winding Np1. A first terminal of the first resonant capacitor Cr1 is coupled to the output terminal of the primary winding Np1, and a second terminal of the first resonant capacitor Cr1 is coupled to the output terminal of the primary winding Np2. The second resonant tank 343 includes a second resonant inductor Lr2 and a second resonant capacitor Cr2. A first terminal of the second resonant inductor Lr2 is coupled to the second output node B, and a second terminal of the second resonant inductor Lr2 is coupled to the input terminal of the primary winding Np2. A first terminal of the second resonant capacitor Cr2 is coupled to the output terminal of the primary winding Np2, and a second terminal of the second resonant capacitor Cr2 is coupled to the output terminal of the primary winding Np3. The third resonant tank 345 includes a third resonant inductor Lr3 and a third resonant capacitor Cr3. A first terminal of the third resonant inductor Lr3 is coupled to the third output node C, and a second terminal of the third resonant inductor Lr3 is coupled to the input terminal of the primary winding Np3. A first terminal of the third resonant capacitor Cr3 is coupled to the output terminal of the primary winding Np3, and a second terminal of the third resonant capacitor Cr3 is coupled to the output terminal of the primary winding Np1. In this embodiment, the output terminal of the primary winding Np1, the output terminal of the primary winding Np2, the output terminal of the primary winding Np3, the first resonant capacitor Cr1, the second resonant capacitor Cr2 and the third resonant capacitor Cr3 are coupled to each other in a delta connection.

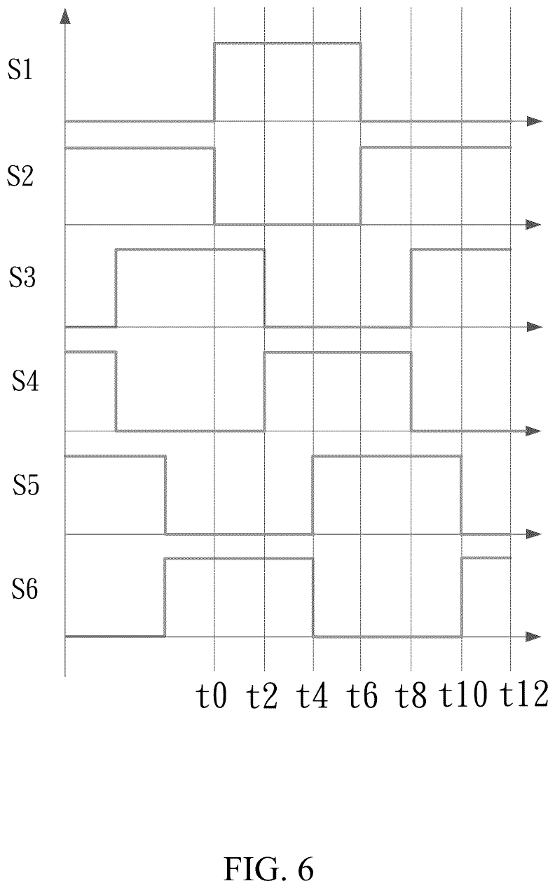

Please refer to FIG. 6, which is a schematic diagram of a first embodiment of control signals according to an embodiment of the present disclosure. In FIG. 6, a horizontal axis represents time, and a vertical axis represents voltage level. FIG. 6 includes the control signals S1 to S6. Each control signal includes a high voltage level and a low voltage level. A phase difference between the control signal S1 and the control signal S2 is 180 degrees, and the control signal S1 and the control signal S2 are complementary to each other. A phase difference between the control signal S3 and the control signal S4 is 180 degrees, and the control signal S3 and the control signal S4 are complementary to each other. A phase difference between the control signal S5 and the control signal S6 is 180 degrees, and the control signal S5 and the control signal S6 are complementary to each other. A phase difference between the control signal S1 and the control signal S3 is 120 degrees. A phase difference between the control signal S3 and the control signal S5 is 120 degrees. A phase difference between the control signal S2 and the control signal S4 is 120 degrees. A phase difference between the control signal S4 and the control signal S6 is 120 degrees.

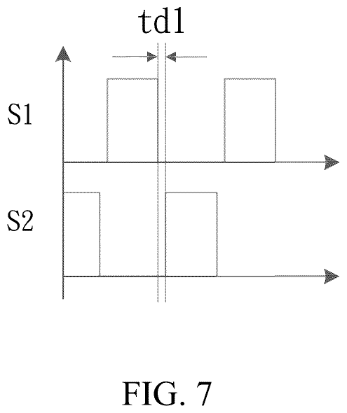

In one embodiment, a first dead time td1 is between the control signal S1 and the control signal S2, a first dead time td1 is between the control signal S3 and the control signal S4, and a first dead time td1 is between the control signal S5 and the control signal S6. As shown in FIG. 7, there is a first dead time dead time td1 between a falling edge of the control signal S1 and a rising edge of the control signal S2. Thereby, switches in the same bridge arm (e.g., the first switching unit SW1 and the second switching unit SW2) may be prevented from being turned on at the same time. In one embodiment, a duration of the first dead time td1 may be determined by parasitic capacitances of the plurality of switch units of the primary switching circuit 200 and the secondary switching circuit 500 and magnetizing inductors of the plurality of transformers. For example, when the magnetizing inductor is small, the switch unit may be discharged quickly, so the duration of the first dead time td1 may be relatively short. When the magnetizing inductor is larger, the switch unit needs a longer discharge time, so the duration of the first dead time td1 may be relatively longer to ensure that the plurality of switch units operate in zero voltage switching.

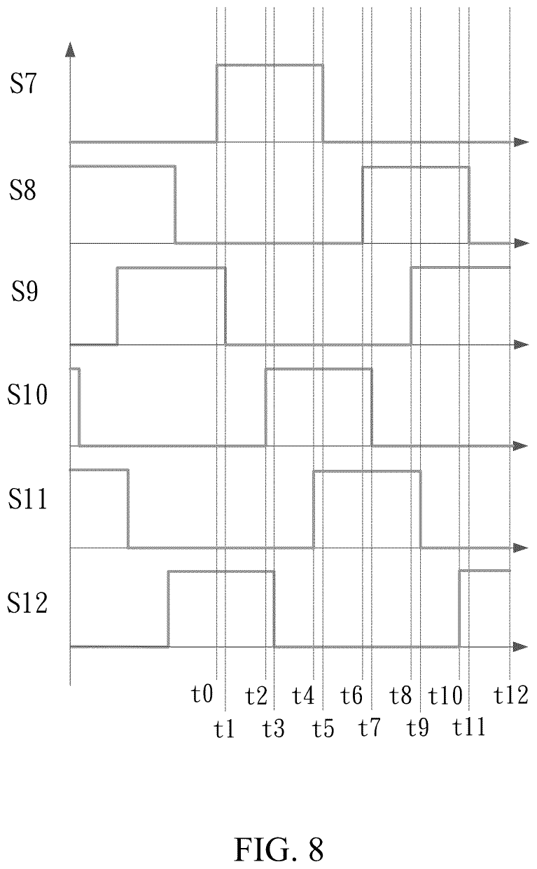

Please refer to FIG. 8, which is a schematic diagram of a second embodiment of control signals according to an embodiment of the present disclosure. In FIG. 8, a horizontal axis represents time, and a vertical axis represents voltage level. FIG. 8 includes the control signals S7 to S12. Each control signal includes a high voltage level and a low voltage level. The control signal S7 and the control signal S8 are complementary to each other. The control signal S9 and the control signal S10 are complementary to each other. The control signal S11 and the control signal S12 are complementary to each other. Thereby, the switches of the same rectifying unit (for example, the seventh switching unit SW7 and the eighth switching unit SW8) may be prevented from being turned on at the same time.

The operation of the resonant converter according to the present disclosure is described below with reference to FIGS. 2, 6, and 8. At time t0 to t1, the first switching unit SW1 is turned on, the second switching unit SW2 is turned off, the third switching unit SW3 is turned on, the fourth switching unit SW4 is turned off, the fifth switching unit SW5 is turned off, and the sixth switching unit SW6 is turned on. The first switching unit SW1 generates and transmits an input current I1 to the first transformer T1 according to the input voltage. The third switching unit SW3 generates and transmits an input current I2 to the second transformer T2 according to the input voltage. The primary of the first transformer T1 generates a first input voltage and a first input current according to the input current I1, and the secondary of the first transformer T1 generates a second output voltage and a second output current according to the first input voltage and the first input current. The operation of the second transformer T2 is similar to that of the first transformer T1 and thus will not be described in detail herein. Accordingly, the seventh switching unit SW7 is turned on, the eighth switching unit SW8 is turned off, the ninth switching unit SW9 is turned off, the tenth switching unit SW10 is turned on, the eleventh switching unit SW11 is turned off, and the twelfth switching unit SW12 is turned on. The seventh switching unit SW7 generates an output current according to the second output voltage of the secondary of the first transformer T1, and the output current is input to the output capacitor Co and the output resistor Ro to generate the output voltage.

At time t1 to t2, the first switching unit SW1 is turned on, the second switching unit SW2 is turned off, the third switching unit SW3 is turned on, the fourth switching unit SW4 is turned off, the fifth switching unit SW5 is turned off, and the sixth switching unit SW6 is turned on. Correspondingly, the seventh switching unit SW7 is turned on, the eighth switching unit SW8 is turned off, the ninth switching unit SW9 is turned off, the tenth switching unit SW10 is turned off, the eleventh switching unit SW11 is turned off, and the twelfth switching unit SW12 is turned on. The seventh switching unit SW7 generates the output current according to the second output voltage of the secondary of the first transformer T1, and the output current is input to the output capacitor Co and the output resistor Ro to generate the output voltage.

At time t2 to t3, the first switching unit SW1 is turned on, the second switching unit SW2 is turned off, the third switching unit SW3 is turned off, the fourth switching unit SW4 is turned on, the fifth switching unit SW5 is turned off, and the sixth switching unit SW6 is turned on. The first switching unit SW1 generates and transmits the input current I1 to the first resonant tank 311 according to the input voltage. Correspondingly, the seventh switching unit SW7 is turned on, the eighth switching unit SW8 is turned off, the ninth switching unit SW9 is turned on, the tenth switching unit SW10 is turned off, the eleventh switching unit SW11 is turned off, and the twelfth switching unit SW12 is turned on. The seventh switching unit SW7 generates the output current according to the second output voltage of the secondary of the first transformer T1, and the output current is input to the output capacitor Co and the output resistor Ro to generate the output voltage.

At time t3 to t4, the first switching unit SW1 is turned on, the second switching unit SW2 is turned off, the third switching unit SW3 is turned off, the fourth switching unit SW4 is turned on, the fifth switching unit SW5 is turned off, and the sixth switching unit SW6 is turned on. Correspondingly, the seventh switching unit SW7 is turned on, the eighth switching unit SW8 is turned off, the ninth switching unit SW9 is turned off, the tenth switching unit SW10 is turned on, the eleventh switching unit SW11 is turned off, and the twelfth switching unit SW12 is turned off. The seventh switching unit SW7 generates the output current according to the second output voltage of the secondary of the first transformer T1, and the output current is input to the output capacitor Co and the output resistor Ro to generate the output voltage.

At time t4 to t5, the first switching unit SW1 is turned on, the second switching unit SW2 is turned off, the third switching unit SW3 is turned off, the fourth switching unit SW4 is turned on, the fifth switching unit SW5 is turned on, and the sixth switching unit SW6 is turned off. The first switching unit SW1 generates and transmits the input current I1 to the first transformer T1. The fifth switching unit SW5 generates and transmits an input current I3 to the third transformer T3 according to the input voltage. The primary of the first transformer T1 generates a first input voltage and a first input current according to the input current I1, and the secondary of the first transformer T1 generates a second output voltage and a second output current according to the first input voltage and the first input current. The operation of the third transformer T3 is similar to that of the first transformer T1 and thus will not be described in detail herein. Correspondingly, the seventh switching unit SW7 is turned on, the eighth switching unit SW8 is turned off, the ninth switching unit SW9 is turned off, the tenth switching unit SW10 is turned on, the eleventh switching unit SW11 is turned on, and the twelfth switching unit SW12 is turned off. The seventh switching unit SW7 generates an output current according to the second output voltage of the secondary of the first transformer T1, and the eleventh switching unit SW11 generates an output current according to the second output voltage of the secondary of the third transformer T3. The output currents are input to the output capacitor Co and the output resistor Ro to generate the output voltage.

At time t5 to t6, the first switching unit SW1 is turned on, the second switching unit SW2 is turned off, the third switching unit SW3 is turned off, the fourth switching unit SW4 is turned on, the fifth switching unit SW5 is turned on, and the sixth switching unit SW6 is turned off. Correspondingly, the seventh switching unit SW7 is turned off, the eighth switching unit SW8 is turned off, the ninth switching unit SW9 is turned off, the tenth switching unit SW10 is turned on, the eleventh switching unit SW11 is turned on, and the twelfth switching unit SW12 is turned off. The eleventh switching circuit SW11 generates an output current according to the second output voltage of the secondary of the third transformer T3, and the output current is input to the output capacitor Co and the output resistor Ro to generate the output voltage.

At time t6 to t7, the first switching unit SW1 is turned off, the second switching unit SW2 is turned on, the third switching unit SW3 is turned off, the fourth switching unit SW4 is turned on, the fifth switching unit SW5 is turned on, and the sixth switching unit SW6 is turned off. The fifth switching unit SW5 generates and transmits the input current I3 to the third transformer T3. The primary of the third transformer T3 generates a first input voltage and a first input current according to the input current I3, and the secondary of the third transformer T3 generates a second output voltage and a second output current according to the first input voltage and the first input current. Correspondingly, the seventh switching unit SW7 is turned off, the eighth switching unit SW8 is turned on, the ninth switching unit SW9 is turned off, the tenth switching unit SW10 is turned on, the eleventh switching unit SW11 is turned on, and the twelfth switching unit SW12 is turned off. The eleventh switching circuit SW11 generates an output current according to the second output voltage of the secondary of the third transformer T3, and the output current is input to the output capacitor Co and the output resistor Ro to generate the output voltage.

At time t7 to t8, the first switching unit SW1 is turned off, the second switching unit SW2 is turned on, the third switching unit SW3 is turned off, the fourth switching unit SW4 is turned on, the fifth switching unit SW5 is turned on, and the sixth switching unit SW6 is turned off. Correspondingly, the seventh switching unit SW7 is turned off, the eighth switching unit SW8 is turned on, the ninth switching unit SW9 is turned off, the tenth switching unit SW10 is turned off, the eleventh switching unit SW11 is turned on, and the twelfth switching unit SW12 is turned off. The eleventh switching circuit SW11 generates the output current according to the second output voltage of the secondary of the third transformer T3, and the output current is input to the output capacitor Co and the output resistor Ro to generate the output voltage.

At time t8 to t9, the first switching unit SW1 is turned off, the second switching unit SW2 is turned on, the third switching unit SW3 is turned on, the fourth switching unit SW4 is turned off, the fifth switching unit SW5 is turned on, and the sixth switching unit SW6 is turned off. The third switching unit SW3 generates and transmits the input current I2 to the second transformer T2. The fifth switching unit SW5 generates and transmits the input current I3 to the third transformer T3. The primary of the second transformer T2 generates a first input voltage and a first input current according to the input current I2, and the secondary of the second transformer T2 generates a second output voltage and a second output current according to the first input voltage and the first input current. The operation of the third transformer T3 is similar to that of the second transformer T2 and thus will not be described in detail herein. Accordingly, the seventh switching unit SW7 is turned off, the eighth switching unit SW8 is turned on, the ninth switching unit SW9 is turned on, the tenth switching unit SW10 is turned off, the eleventh switching unit SW11 is turned on, and the twelfth switching unit SW12 is turned off. The ninth switching unit SW9 generates an output current according to the second output voltage of the secondary of the second transformer T2. The eleventh switching circuit SW11 generates an output current according to the second output voltage of the secondary of the third transformer T3. The output current is input to the output capacitor Co and the output resistor Ro to generate the output voltage.

At time t9 to t10, the first switching unit SW1 is turned off, the second switching unit SW2 is turned on, the third switching unit SW3 is turned on, the fourth switching unit SW4 is turned off, the fifth switching unit SW5 is turned on, and the sixth switching unit SW6 is turned off. Correspondingly, the seventh switching unit SW7 is turned off, the eighth switching unit SW8 is turned on, the ninth switching unit SW9 is turned on, the tenth switching unit SW10 is turned off, the eleventh switching unit SW11 is turned off, and the twelfth switching unit SW12 is turned off. The ninth switching unit SW9 generates an output current according to the second voltage of the secondary of the second transformer T2. The output current is input to the output capacitor Co and the output resistor Ro to generate the output voltage.

At time t10 to t11, the first switching unit SW1 is turned off, the second switching unit SW2 is turned on, the third switching unit SW3 is turned on, the fourth switching unit SW4 is turned off, the fifth switching unit SW5 is turned off, and the sixth switching unit SW6 is turned on. The third switching unit SW3 generates and transmits the input current I2. The primary of the second transformer T2 generates a first input voltage and a first input current, and the secondary of the second transformer T2 generates a second output voltage and a second output current according to the first input voltage and the first input current. Correspondingly, the seventh switching unit SW7 is turned off, the eighth switching unit SW8 is turned on, the ninth switching unit SW9 is turned on, the tenth switching unit SW10 is turned off, the eleventh switching unit SW11 is turned off, and the twelfth switching unit SW12 is turned on. The ninth switching unit SW9 generates an output current according to the second output voltage of the secondary of the second transformer T2, and the output current is input to the output capacitor Co and the output resistor Ro to generate the output voltage.

At time t11 to t12, the first switching unit SW1 is turned off, the second switching unit SW2 is turned on, the third switching unit SW3 is turned on, the fourth switching unit SW4 is turned off, the fifth switching unit SW5 is turned off, and the sixth switching unit SW6 is turned on. Correspondingly, the seventh switching unit SW7 is turned off, the eighth switching unit SW8 is turned off, the ninth switching unit SW9 is turned on, the tenth switching unit SW10 is turned off, the eleventh switching unit SW11 is turned off, and the twelfth switching unit SW12 is turned on. The ninth switching unit SW9 generates an output current according to the second output voltage of the secondary of the second transformer T2, and the output current is input to the output capacitor Co and the output resistor Ro to generate the output voltage.

In one embodiment, under the same ZVS current condition, specifications of a half-bridge to half-bridge resonant converter and specifications of a resonant converter of the present disclosure may be determined as shown in Table 1 and Table 2.

TABLE 1

| | Half-bridge to half- | | Resonant converter | |
|---|---|---|---|---|
| | bridge resonant | | of the present | |
| Specifications | converter | | disclosure | |
| Input voltage | 400 | V | 400 | V |
| Output voltage | 49.58 | V | 49.47 | V |
| Output wattage | 10 | kW | 10 | kW |
| Switching frequency | 100 | kHz | 100 | kHz |
| Operating point | On resonant point | | On resonant point | |
| (full load) | | | | |
| Capacitor of the | 105 | pF | 105 | pF |
| primary switch | | | | |
| Dead time | 50 | ns | 50 | ns |
| Turns ratio | 16:2 | | 10:2 | |
| Magnetizing inductance | 157.34 | μH | 131.25 | μH |
| Resonant capacitor | 0.38 | μF | 0.39 | nF |
| Resonant inductor | 6 | μH | 6 | μH |
| Leakage inductance | 0.64 | μH | 0.37 | μH |

It should be noted that the turns ratio of the first transformer T1, the turns ratio of the second transformer T2, and the turns ratio of the third transformer T3 may be set to a value of turns ratios shown in Table 1. The first dead time td1 may be set to a value of the dead time shown in Table 1. The magnetizing inductors Lm1, Lm2 and Lm3 may be set to a value of the magnetizing inductance shown in Table 1. The first resonant capacitor Cr1, the second resonant capacitor Cr2 and the third resonant capacitor Cr3 may be set to a value of the resonant capacitor shown in Table 1. The first resonant inductor Lr1, the second resonant inductor Lr2, and the third resonant inductor Lr3 may be set to a value of the resonant inductor shown in Table 1. Therefore, compared with a half-bridge to half-bridge resonant converter, the embodiment of the present disclosure may reduce a number of primary coils.

TABLE 2

| | Half-bridge to half- | | Resonant converter | |
|---|---|---|---|---|
| | bridge resonant | | of the present | |
| Specifications of core | converter | | disclosure | |
| Cross-sectional area of | 174.04 | mm² | 174.04 | mm² |
| core center column (Ae) | | | | |
| Material | KF9 | | KF9 | |
| Maximum magnetic | 0.25 | T | 0.25 | T |
| flux density | | | | |
| (Assumption) | | | | |
| Primary coil | 0.1*500 | strands | 0.1*500 | strands |
| Secondary coil | Copper Sheet 0.6 mm | | Copper Sheet 0.6 mm | |
| Turns ratio | 16:2 | | 14:1 | |
| Air gap | 0.38 | mm | 0.158 | mm |

It should be noted that the primary winding Np1 of the first transformer T1, the primary winding Np2 of the second transformer T2 and the primary winding Np3 of the third transformer T3 may be set to the primary coil shown in Table 2. The secondary winding Ns1 of the first transformer T1, the secondary winding Ns2 of the second transformer T2, and the secondary winding Ns3 of the third transformer T3 may be set to the secondary coil shown in Table 2.

The performance of the half-bridge to half-bridge resonant converter and the performance of a resonant converter of the present disclosure are shown in Table 3 and Table 4.

TABLE 3

| | Half-bridge to half- | Resonant converter |
|---|---|---|
| | bridge resonant | of the present |
| Performance parameters | converter | disclosure |
| Primary switch current | 26.33 | 31.89 |
| peak value (A) | | |
| Primary switch current | 13.16 | 13.44 |
| effective value (A) | | |
| Primary transformer | 18.61 | 19 |
| current effective value (A) | | |
| Primary switch number | 6 | 6 |
| Secondary switch current | 208.16 | 151.49 |
| peak value (A) | | |
| Secondary switch current | 103.92 | 92.92 |
| effective value (A) | | |
| Secondary transformer | 146.95 | 113.82 |
| current effective value (A) | | |
| Secondary switch number | 6 | 6 |
| Resonant inductor current | 18.59 | 19.01 |

It should be noted that the primary switch of Table 3 may be the primary switching circuit 200, the primary transformer of Table 3 may be the primary of the transformer circuit 400, the secondary switch of Table 3 may be the secondary switching circuit 500, and the secondary transformer of Table 3 may be the secondary of the transformer circuit 400. As shown in Table 3, compared with the half-bridge to half-bridge resonant converter, the embodiment of the disclosure has a smaller secondary switch current peak value, secondary switch current effective value and secondary transformer current effective value. That is, the embodiment of the present disclosure has a smaller secondary current stress compared to the half-bridge to half-bridge resonant converter.

TABLE 4

| | Half-bridge to half- | |
|---|---|---|
| | bridge resonant | Resonant converter of |
| Performance parameters | converter | the present disclosure |
| Primary connection | Half-bridge | According to the |
| | | present disclosure |
| Secondary connection | Half-bridge | Delta connection |
| Output voltage | Vo | Vo |
| Turns ratio | Np | Np * 0.6 |
| Operating frequency | On resonant point | On resonant point |
| Maximum magnetic flux density | $\frac{1}{8} \cdot \frac{Nps \cdot {V}_{o} \cdot {T}_{s}}{NP \cdot A}$ | $\approx \frac{1}{6} \cdot \frac{Nps \cdot {V}_{o} \cdot {T}_{s}}{NP \cdot A}$ |
| Current Peak Value (calculating ZVS | $\frac{1}{8} \cdot \frac{Nps \cdot {V}_{o} \cdot {T}_{s}}{{L}_{m \_ H}}$ | $\frac{1}{3.75} \cdot \frac{Nps \cdot {V}_{o} \cdot {T}_{s}}{{L}_{m \_ Y}}$ |
| condition) | | |
| Magnetizing inductance | ${L}_{m \_ H} = \frac{9}{8} \cdot {L}_{m}$ | Lₘ_Y ≈ 1.55 · Lₘ_H |

As shown in Table 4, under the condition of the same excitation current peak value, the resonant converter of the embodiment of the present disclosure has fewer primary coils than the half-bridge to half-bridge resonant converter. In addition, compared with the half-bridge to half-bridge resonant converter, the embodiment of the present disclosure has a smaller secondary current stress.

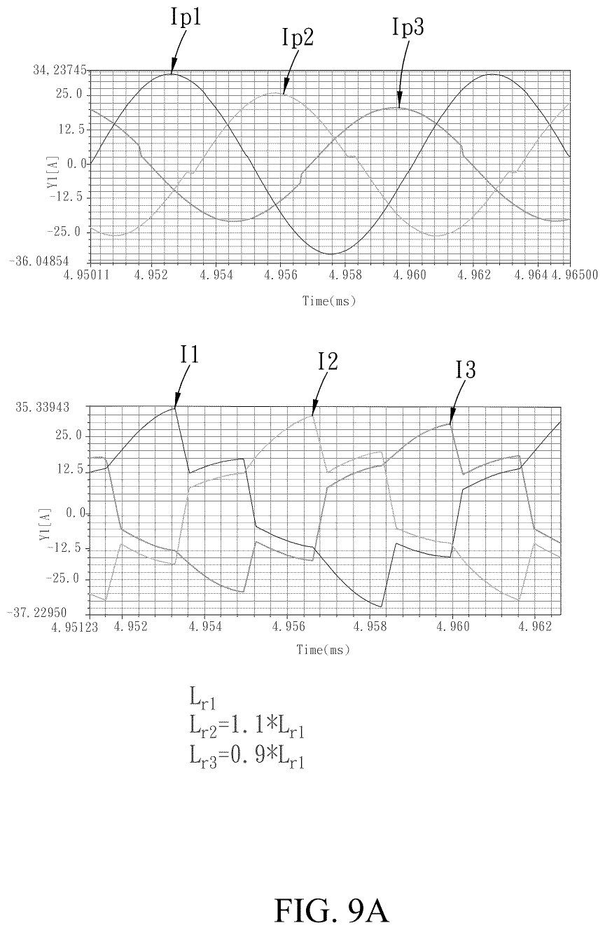

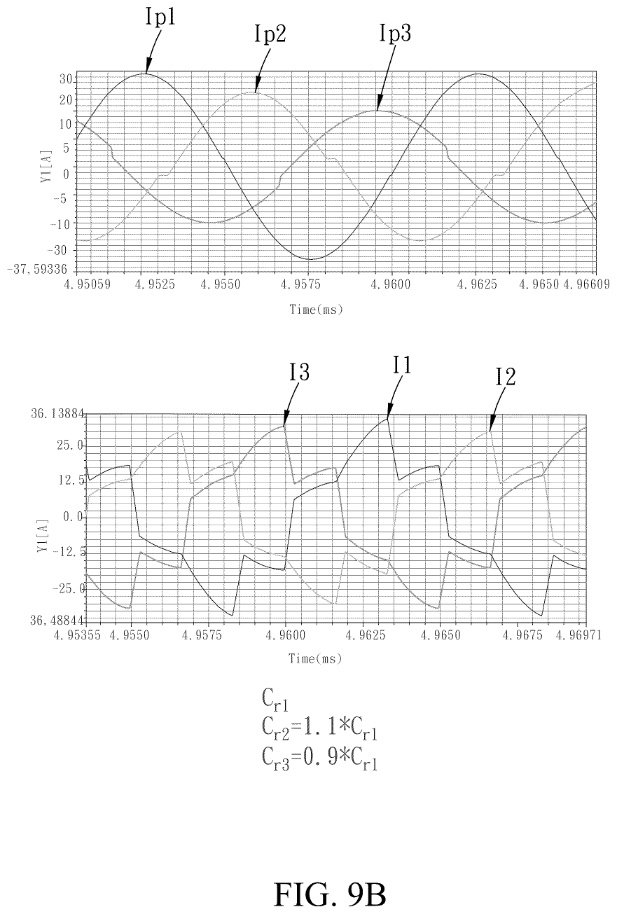

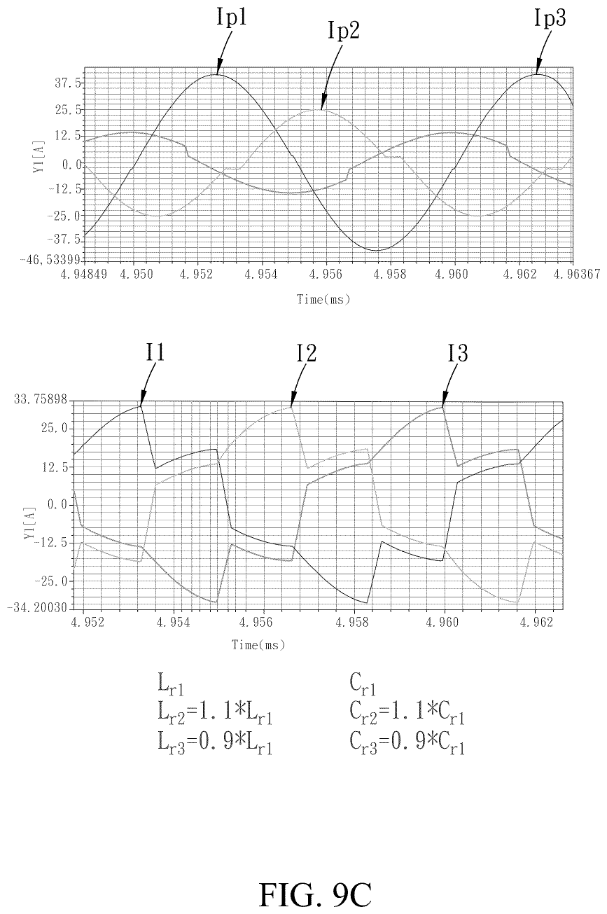

Please refer to FIG. 2, FIG. 9A, FIG. 9B, and FIG. 9C. FIG. 9A, FIG. 9B and FIG. 9C are comparison diagrams of three-phase current errors of a resonant converter according to an embodiment of the present disclosure and a half-bridge to half-bridge resonant converter.

FIG. 9A shows current variation values when a value of the second resonant inductor Lr2 is 1.1 times a value of the first resonant inductor Lr1 and a value of the third resonant inductor Lr3 is 0.9 times a value of the first resonant inductor Lr1. The upper part of FIG. 9A shows the current variation values of a first current Ip1, a second current Ip2 and a third current Ip3 of a half-bridge to half-bridge resonant converter. The lower part of FIG. 9A shows the current variation values of the input current I1, the input current I2, and the input current I3 of the resonant converter according to the embodiment of the present disclosure. The first current Ip1 is in phase with the input current I1, the second current Ip2 is in phase with the input current I2, and the third current Ip3 is in phase with the input current I3. FIG. 9B shows current change values when a value of the second resonant capacitor Cr2 is 1.1 times a value of the first resonant capacitor Cr1 and a value of the third resonant capacitor Cr3 is 0.9 times a value of the first resonant capacitor Cr1. The upper part of FIG. 9B shows the current variation values of a first current Ip1, a second current Ip2 and a third current Ip3 of a half-bridge to half-bridge resonant converter. The lower part of FIG. 9B shows the current variation values of the input current I1, the input current I2, and the input current I3 of the resonant converter according to the embodiment of the present disclosure. The first current Ip1 is in phase with the input current I1, the second current Ip2 is in phase with the input current I2, and the third current Ip3 is in phase with the input current I3. FIG. 9C shows current change values when a value of the second resonant inductor Lr2 is 1.1 times a value of the first resonant inductor Lr1 and a value of the third resonant inductor Lr3 is 0.9 times a value of the first resonant inductor Lr1, and a value of the second resonant capacitor Cr2 is 1.1 times a value of the first resonant capacitor Cr1 and a value of the third resonant capacitor Cr3 is 0.9 times a value of the first resonant capacitor Cr1. The upper part of FIG. 9C shows current variation values of a first current Ip1, a second current Ip2 and a third current Ip3 of the half-bridge to half-bridge resonant converter. The lower part of FIG. 9C shows current variation values of the input current I1, the input current I2, and the input current I3 of the resonant converter according to the embodiment of the present disclosure. The first current Ip1 is in phase with the input current I1. The second current Ip2 is in phase with the input current I2. The third current Ip3 is in phase with the input current I3. As shown in the figures, under different component errors, peak value differences of the input current I1, the input current I2 and the input current I3 of the embodiment of the present disclosure under different component errors is smaller than peak value differences of the first current Ip1, the second current Ip2 and the third current Ip3 under different component errors. That is, current differences caused by the component error of the resonant converter of the embodiment of the present disclosure are smaller than current differences caused by the component error of the half-bridge to half-bridge resonant converter. Therefore, the resonant converter of the present disclosure has a higher tolerance to the current error caused by the component error.

The performance of the half-bridge to half-bridge resonant converter and the performance of a resonant converter of the present disclosure are shown in Table 5 and Table 6.

TABLE 5

| | | Half-bridge to half- | Resonant converter |
|---|---|---|---|
| | | bridge resonant | of the present |
| Resonant inductor current | | converter | disclosure |
| Component | I_{Lr1} | 18.6 A | 19.01 A |
| error-free | I_{Lr2} | 18.6 A | 19.01 A |
| | I_{Lr3} | 18.6 A | 19.01 A |
| Resonant | I_{Lr1} | 23.07 A (+24.03%) | 19.53 A (+2.76%) |
| inductor error | I_{Lr2} | 15.02 A (+19.24%) | 18.30 A (−3.73%) |
| | I_{Lr3} | 17.98 A (+3.33%) | 18.93 A (−0.42%) |
| Resonant | I_{Lr1} | 23.37 A (+25.64%) | 19.49 A (+2.52%) |
| capacitor error | I_{Lr2} | 14.50 A (−22.04%) | 19.09 A (+0.42%) |
| | I_{Lr3} | 18.25 A (−1.88%) | 18.38 A (−3.31%) |
| Resonant | I_{Lr1} | 29.20 A (+56.89%) | 18.90 A (−0.57%) |
| inductor and | I_{Lr2} | 10.43 A (−43.92%) | 18.97 A (−0.21%) |
| resonant | I_{Lr3} | 16.90 A (+16.57%) | 19.23 A (+1.15%) |
| capacitor error | | | |

In Table 5, I_{Lr1}, I_{Lr2} and I_{Lr3} represent currents of the first resonant inductor Lr1, the second resonant inductor Lr2 and the third resonant inductor Lr3 respectively. As shown in Table 5, when there are errors in the components of the resonant converter of the embodiment of the present disclosure, the current change values of the resonant inductor are significantly smaller than the current change values of the resonant inductor of the half-bridge to half-bridge resonant converter. The current differences caused by component errors in the resonant converter of the embodiment of the present disclosure are smaller than the current differences caused by component errors in the half-bridge to half-bridge resonant converter.

TABLE 6

| | | Primary | Secondary | Transformer |
|---|---|---|---|---|
| | Magnetic | Copper | Copper | total |
| | loss (W) | loss (W) | loss (W) | loss (W) |
| Half-bridge to | 2.77 | 3.97 | 9.09 | 15.83 |
| half-bridge | | | | |
| resonant | | | | |
| converter | | | | |
| Resonant | 7.6 | 2.94 | 3.36 | 13.9 |
| converter of the | | | | |
| present | | | | |
| disclosure | | | | |

As shown in Table 6, the copper loss of the embodiment of the present disclosure on the primary and the secondary is smaller than that of the half-bridge to half-bridge resonant converter, and the total loss of the transformer of the embodiment of the present disclosure is also smaller than that of the half-bridge to half-bridge resonant converter. The conversion efficiency of the transformer in the embodiment of the present disclosure is higher than that of the half-bridge to half-bridge resonant converter.

In the embodiment of the present disclosure, the plurality of resonant inductors and the plurality of transformers of the resonant converter may be implemented by separate magnetic cores or by a single integrated magnetic core module.

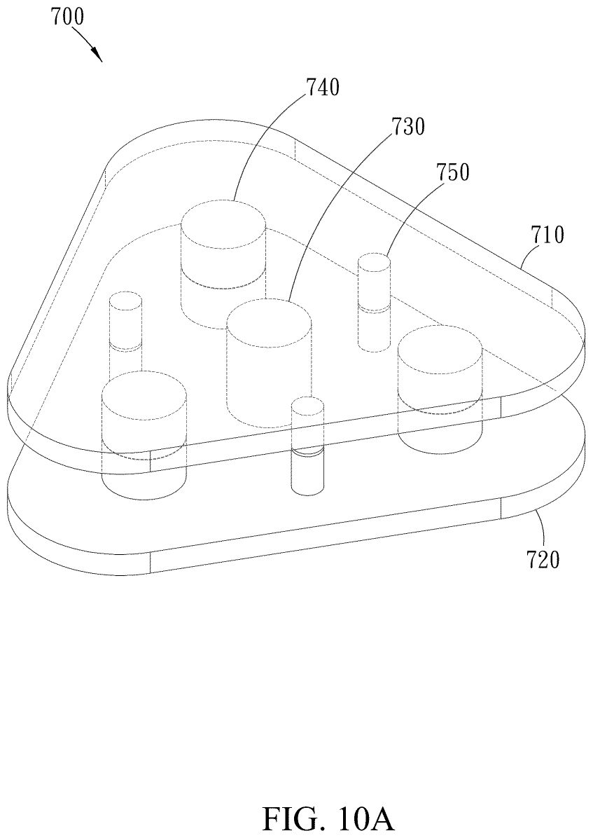

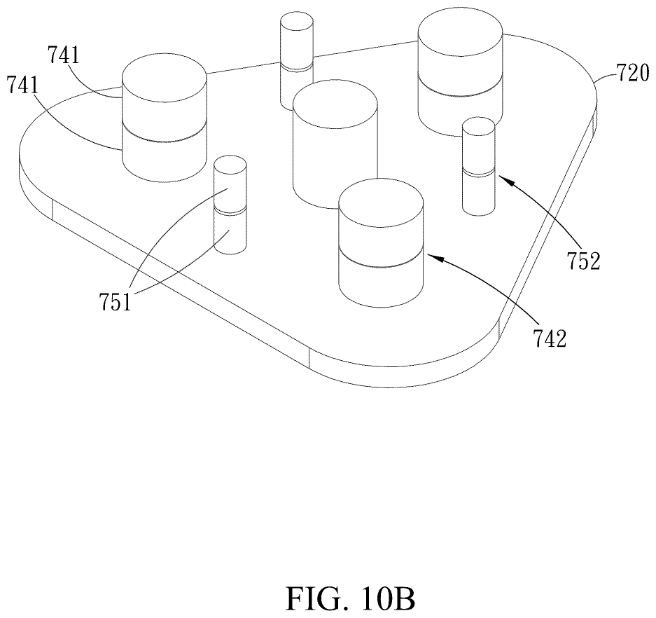

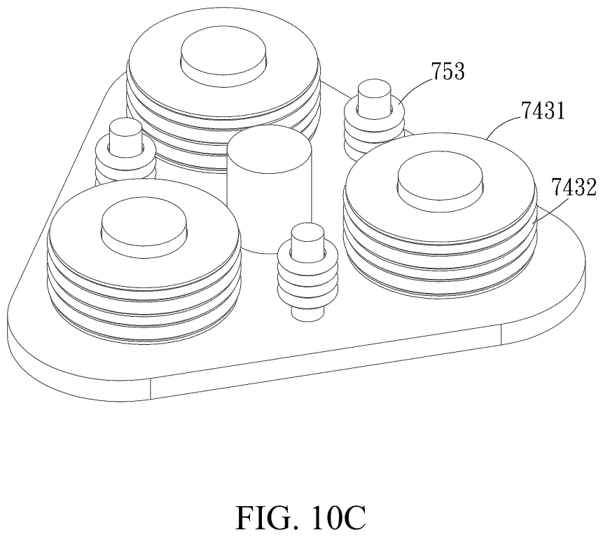

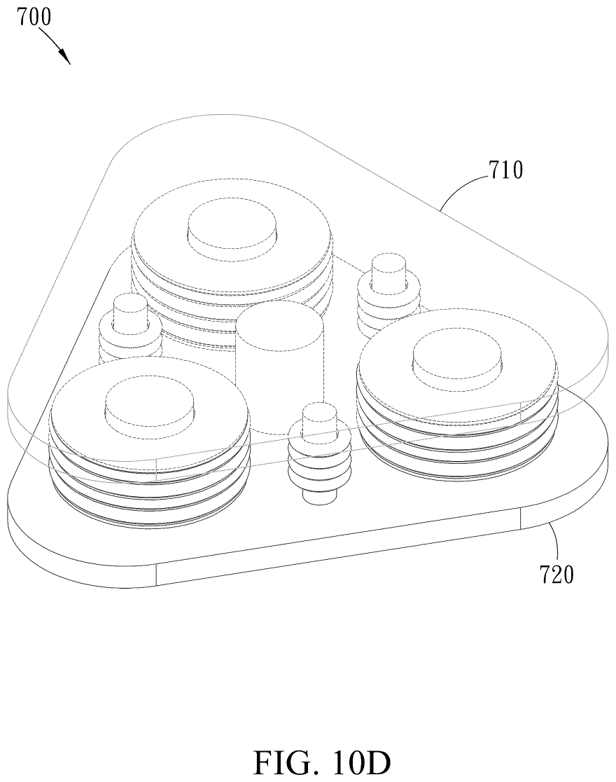

Please refer to FIG. 10A to FIG. 10D. FIG. 10A to FIG. 10D are schematic diagrams of an integrated magnetic core module according to an embodiment of the present disclosure. The integrated magnetic core module 700 includes an upper cover 710, a lower cover 720, a plurality of transformer core columns 740, a plurality of inductor core columns 750, and a common column 730. The plurality of transformer core columns 740, the plurality of inductor core columns 750, and the common column 730 are disposed between the upper cover 710 and the lower cover 720. The plurality of transformer core columns 740 and the plurality of inductor core columns 750 are disposed around the common column 730. The plurality of transformer core columns 740 and the plurality of inductor core columns 750 are arranged alternately with each other. Each inductor core column 750 is located between two transformer core columns 740. Distances between the plurality of transformer core columns 740 and the common column 730 are the same, and distances between the plurality of inductor core columns 750 and the common column 730 are the same. Since the distances between the plurality of transformer core columns 740 and the common column 730 are the same and the distances between the plurality of inductor core columns 750 and the common column 730 are the same, a magnetic flux balance between the phases may be effectively maintained. In one embodiment, the common column 730 may be disposed at the center of the lower cover 720.

The cross-sectional areas of each of the plurality of transformer core columns 740 are equal. The cross-sectional area of each of the plurality of transformer core columns 740 is the same as a cross-sectional area of the common column 730. Each transformer core column 740 includes two core column units 741. The two core column units 741 are stacked on each other. An air gap 742 is formed between the two core column units 741. The sizes of the air gaps 742 of each transformer core column 740 are the same.

The cross-sectional areas of each of the plurality of inductor core columns 750 are equal. The cross-sectional area of each of the plurality of transformer core columns 740 is greater than the cross-sectional area of each of the plurality of inductor core columns 750. In one embodiment, the cross-sectional area of the transformer core column 740 is at least twice the cross-sectional area of the inductor core column 750. Each inductor core column 750 includes two core column units 751. The two core column units 751 are stacked on top of each other. An air gap 752 is formed between the two core column units 751. The sizes of the air gaps 752 of each inductor core column 750 are the same. In one embodiment, the size of the air gap 752 of each of the plurality of inductor core columns 750 is greater than the size of the air gap 742 of each of the plurality of transformer core columns 740. In one embodiment, the size of the air gap 752 of the inductor core column 750 is at least three times the size of the air gap 742 of the transformer core columns 740.

Each transformer core column 740 is configured to dispose a primary coil 7431 and a secondary coil 7432. A winding direction of the primary coil 7431 and the secondary coil 7432 is clockwise or counterclockwise. The primary coil 7431 is, for example, the aforementioned primary winding Np1, primary winding Np2 or primary winding Np3. The secondary coil 7432 is, for example, the aforementioned secondary winding Ns1, the secondary winding Ns2 or the secondary winding Ns3. Therefore, the above-mentioned plurality of transformers (the first transformer T1, the second transformer T2 and the third transformer T3) may be individually implemented by a set of the transformer core columns 740, the primary coil 7431 and the secondary coil 7432. The positions of the plurality of transformers in the integrated magnetic core module 700 may be adjusted as required.

In one embodiment, the primary coil 7431 is wound from, for example, a Litz wire. Since the air gap 742 is located at a center of the transformer core column 740, an AC loss caused by the air gap 742 may be effectively reduced by the Litz wire. In one embodiment, the secondary coil 7432 is wound from, for example, a copper sheet. Since the current of the secondary coil 7432 is relatively large, a copper sheet that may carry a relatively large current is selected.

Each of the inductor core columns 750 is provided with an inductor coil 753. The winding direction of the inductor coil 753 is a clockwise direction or a counterclockwise direction. Therefore, the aforementioned plurality of resonant inductors (the first resonant inductor Lr1, the second resonant inductor Lr2, and the third resonant inductor Lr3) may be individually implemented by a set of inductor core columns 750 and inductor coils 753. The positions of the plurality of resonant inductors in the integrated magnetic core module 700 may be adjusted as required.

In one embodiment, the inductor coil 753 is formed by a Litz wire. Since the air gap 752 is located at the center of the inductor core column 750, an AC loss caused by the air gap 752 may be effectively reduced by the Litz wire.

In one embodiment, the shapes of the upper cover 710 and the lower cover 720 may correspond to each other. The upper cover 710 and the lower cover 720 may be in the shape of a circular plate, a square plate, or a triangular plate, and the present disclosure is not limited thereto.

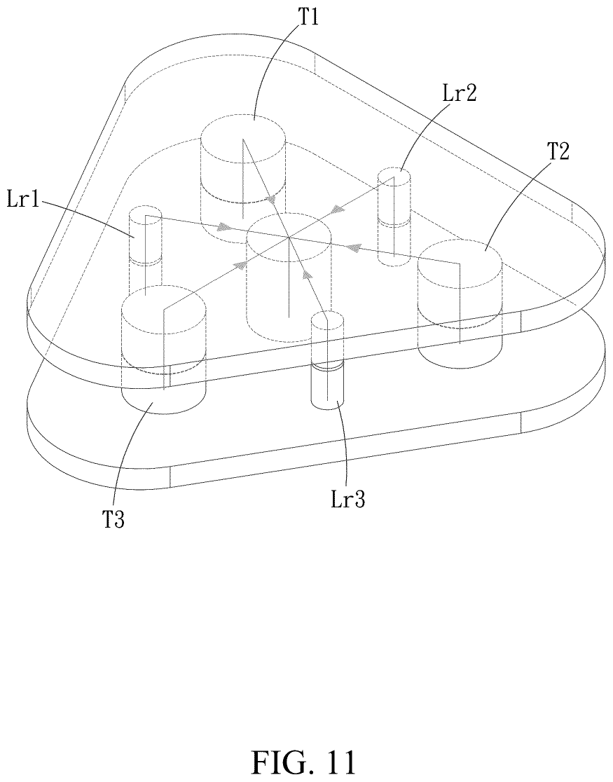

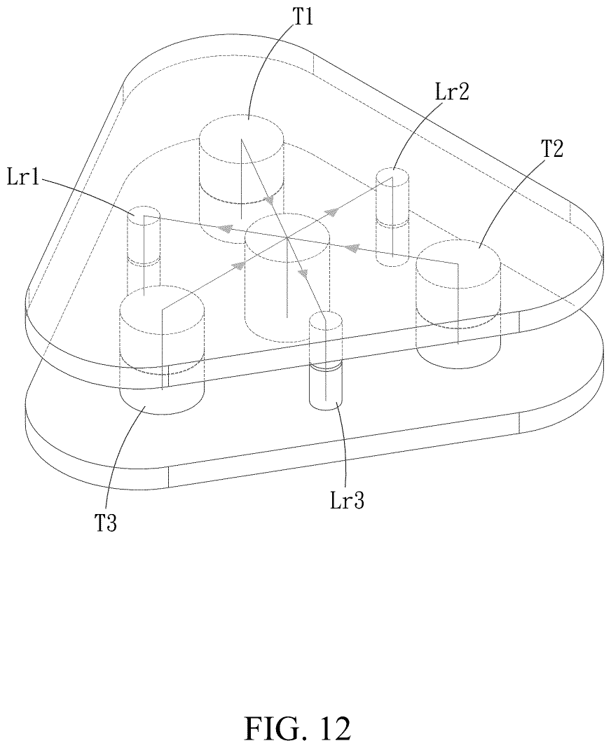

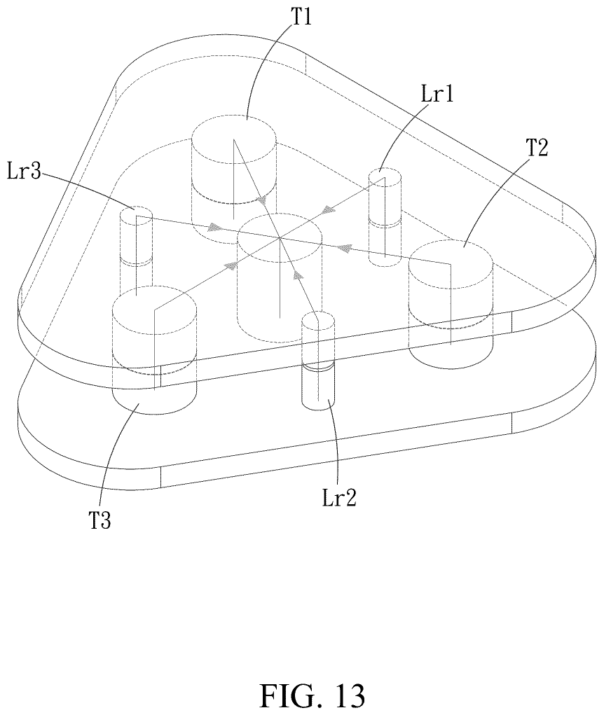

Please refer to FIG. 11 to FIG. 13. FIG. 11 to FIG. 13 are schematic diagrams of embodiments of configuration positions of transformers and resonant inductors. In the first embodiment of FIG. 11, in clockwise order are the first transformer T1, the second resonant inductor Lr2, the second transformer T2, the third resonant inductor Lr3, the third transformer T3 and the first resonant inductor Lr1. The winding direction of the coils of the first transformer T1, the second transformer T2 and the third transformer T3 is the same as the winding direction of the coils of the first resonant inductor Lr1, the second resonant inductor Lr2 and the third resonant inductor Lr3. Directions of the magnetic flux of the first transformer T1, the second transformer T2, the third transformer T3, the first resonant inductor Lr1, the second resonant inductor Lr2, and the third resonant inductor Lr3 are the same. In the second embodiment of FIG. 12, in clockwise order are the first transformer T1, the second resonant inductor Lr2, the second transformer T2, the third resonant inductor Lr3, the third transformer T3 and the first resonant inductor Lr1. In this embodiment, the winding direction of the coils of the first transformer T1, the second transformer T2 and the third transformer T3 is different from the winding direction of the coils of the first resonant inductor Lr1, the second resonant inductor Lr2 and the third resonant inductor Lr3. Directions of the magnetic flux of the first transformer T1, the second transformer T2 and the third transformer T3 are different from directions of the first resonant inductor Lr1, the second resonant inductor Lr2 and the third resonant inductor Lr3. In the third embodiment of FIG. 13, in clockwise order are the first transformer T1, the first resonant inductor Lr1, the second transformer T2, the second resonant inductor Lr2, the third transformer T3, and the third resonant inductor Lr3. The winding direction of the coils of the first transformer T1, the second transformer T2 and the third transformer T3 is the same as the winding direction of the coils of the first resonant inductor Lr1, the second resonant inductor Lr2 and the third resonant inductor Lr3. Directions of the magnetic flux of the first transformer T1, the second transformer T2, the third transformer T3, the first resonant inductor Lr1, the second resonant inductor Lr2, and the third resonant inductor Lr3 are the same.

The performance of the integrated magnetic core module 700 of FIG. 11 to FIG. 13 is shown in Table 7.

TABLE 7

| | First | Second | third |
|---|---|---|---|
| Core loss | embodiment | embodiment | embodiment |
| Upper cover (W) | 1.83 | 2.16 | 2.12 |
| Lower cover (W) | 1.83 | 2.16 | 2.12 |
| First transformer (W) | 0.8 | 0.8 | 0.8 |
| Second transformer (W) | 0.8 | 0.8 | 0.8 |
| Third transformer (W) | 0.8 | 0.8 | 0.8 |
| First resonant inductor (W) | 0.14 | 0.14 | 0.14 |
| Second resonant inductor (W) | 0.14 | 0.14 | 0.14 |
| Third resonant inductor (W) | 0.14 | 0.14 | 0.14 |
| Common column (W) | 0.28 | 0.3 | 0.3 |
| Total loss (W) | 6.76 | 7.44 | 7.36 |

As shown in Table 7, by the configuration of the embodiment of FIG. 11, the magnetic fluxes of the upper cover 710 and the lower cover 720 may be offset, thereby reducing the total loss of the integrated magnetic core module 700.

In summary, since the resonant converter of the present disclosure may reduce the core loss by the configurations of the resonant tanks and the integrated magnetic core module and has a better current balancing effect when there are characteristic errors in the components, the effect of reducing the overall loss of the power supply circuit is achieved.

It is to be understood that the term “comprises”, “comprising”, or any other variants thereof, is intended to encompass a non-exclusive inclusion, such that a process, method, article, or device of a series of elements not only includes those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present invention has been explained in relation to its preferred embodiments, the explanation is not intended to limit the present invention. It will be apparent to those skilled in the art having regard to this present invention that other modifications of the exemplary embodiments beyond those embodiments specifically described here may be made without departing from the spirit of the invention. Accordingly, such modifications are considered within the scope of the invention as limited solely by the appended claims.

What is claimed is:

1. A resonant converter, comprising:
an input circuit, configured to provide an input voltage;
a primary switching circuit, coupled to the input circuit, and comprising a plurality of output nodes;
a resonant circuit, electrically connected to the primary switching circuit, comprising a plurality of resonant tanks, the plurality of resonant tanks comprising a plurality of resonant inductors;
a transformer circuit, coupled to the resonant circuit, comprising a plurality of transformers, wherein each of the plurality of transformers comprises a primary winding and a secondary winding, the primary winding comprises an input terminal and an output terminal, the primary windings are coupled to each other in a Wye connection, and the secondary windings are coupled to each other in a delta connection;
a secondary switching circuit, coupled to the transformer circuit, comprising a plurality of input nodes, wherein the plurality of input nodes are coupled to the secondary windings of the transformer circuit in a Wye connection; and
an output circuit, coupled to the secondary switching circuit and generating an output voltage.

2. The resonant converter as claimed in claim 1, the primary switching circuit comprising:
a first bridge arm, comprising a first switching unit and a second switching unit connected in series, wherein a first output node is located between the first switching unit and the second switching unit;
a second bridge arm, comprising a third switching unit and a fourth switching unit connected in series, wherein a second output node is located between the third switching unit and the fourth switching unit; and
a third bridge arm, comprising a fifth switching unit and a sixth switching unit connected in series, wherein a third output node is located between the fifth switching unit and the sixth switching unit.

3. The resonant converter as claimed in claim 2, wherein a control signal of the first switching unit and a control signal of the second switching unit are complementary to each other, a control signal of the third switching unit and a control signal of the fourth switching unit are complementary to each other, and a control signal of the fifth switching unit and a control signal of the sixth switching unit are complementary to each other.

4. The resonant converter as claimed in claim 3, wherein a first dead time is between the control signal of the first switching unit and the control signal of the second switching unit, between the control signal of the third switching unit and the control signal of the fourth switching unit, and between the control signal of the fifth switching unit and the control signal of the sixth switching unit.

5. The resonant converter as claimed in claim 2, wherein a phase difference between the control signal of the first switching unit and the control signal of the third switching unit is 120 degrees, and a phase difference between the control signal of the third switching unit and the control signal of the fifth switching unit is 120 degrees.

6. The resonant converter as claimed in claim 1, wherein the transformer circuit comprises a first transformer, a second transformer and a third transformer, and the output terminal of the primary winding of the first transformer, the output terminal of the primary winding of the second transformer and the output terminal of the primary winding of the third transformer are coupled to the resonant circuit.

7. The resonant converter as claimed in claim 6, the resonant circuit comprising:
a first resonant tank, comprising a first resonant inductor and a first resonant capacitor connected in series, wherein the first resonant inductor is coupled to the output terminal of the primary winding of the first transformer, and the first resonant capacitor is coupled to the output terminal of the primary winding of the second transformer;
a second resonant tank, comprising a second resonant inductor and a second resonant capacitor connected in series, wherein the second resonant inductor is coupled to the output terminal of the primary winding of the second transformer, and the second resonant capacitor is coupled to the output terminal of the primary winding of the third transformer; and
a third resonant tank, comprising a third resonant inductor and a third resonant capacitor connected in series, wherein the third resonant inductor is coupled to the output terminal of the primary winding of the third transformer, and the third resonant capacitor is coupled to the output terminal of the primary winding of the first transformer.

8. The resonant converter as claimed in claim 6, the resonant circuit comprising:
a first resonant tank, comprising a first resonant inductor and a first resonant capacitor, wherein the first resonant inductor is coupled between the output terminal of the primary winding of the first transformer and the output terminal of the primary winding of the second transformer, and the first resonant capacitor is coupled between a first output node of the primary switching circuit and the input terminal of the primary winding of the first transformer;
a second resonant tank, comprising a second resonant inductor and a second resonant capacitor, wherein the second resonant inductor is coupled between the output terminal of the primary winding of the second transformer and the output terminal of the primary winding of the third transformer, and the second resonant capacitor is coupled between a second output node of the primary switching circuit and the input terminal of the primary winding of the second transformer; and
a third resonant tank, comprising a third resonant inductor and a third resonant capacitor, wherein the third resonant inductor is coupled between the output terminal of the primary winding of the third transformer and the output terminal of the primary winding of the first transformer, and the third resonant capacitor is coupled between a third output node of the primary switching circuit and the input terminal of the primary winding of the third transformer.

9. The resonant converter as claimed in claim 6, the resonant circuit comprising:
a first resonant tank, comprising a first resonant inductor and a first resonant capacitor, wherein the first resonant capacitor is coupled to a first output node of the primary switching circuit and the first resonant inductor, and the first resonant inductor is coupled to the input terminal of the primary winding of the first transformer;
a second resonant tank, comprising a second resonant inductor and a second resonant capacitor, wherein the second resonant capacitor is coupled to a second output node of the primary switching circuit and the second resonant inductor, and the second resonant inductor is coupled to the input terminal of the primary winding of the second transformer; and
a third resonant tank, comprising a third resonant inductor and a third resonant capacitor, wherein the third resonant capacitor is coupled to a third output node of the primary switching circuit and the third resonant inductor, and the third resonant inductor is coupled to the input terminal of the primary winding of the third transformer.

10. The resonant converter as claimed in claim 6, the resonant circuit comprising:
a first resonant tank, comprising a first resonant inductor and a first resonant capacitor, wherein the first resonant capacitor is coupled between the output terminal of the primary winding of the first transformer and the output terminal of the primary winding of the second transformer, and the first resonant inductor is coupled between a first output node of the primary switching circuit and the input terminal of the primary winding of the first transformer;
a second resonant tank, comprising a second resonant inductor and a second resonant capacitor, wherein the second resonant capacitor is coupled between the output terminal of the primary winding of the second transformer and the output terminal of the primary winding of the third transformer, and the second resonant inductor is coupled between a second output node of the primary switching circuit and the input terminal of the primary winding of the second transformer; and
a third resonant tank, comprising a third resonant inductor and a third resonant capacitor, wherein the third resonant capacitor is coupled between the output terminal of the primary winding of the third transformer and the output terminal of the primary winding of the first transformer, and the third resonant inductor is coupled between a third output node of the primary switching circuit and the input terminal of the primary winding of the third transformer.

11. The resonant converter as claimed in claim 6, the secondary switching circuit comprising:
a first rectification unit, comprising a seventh switching unit and an eighth switching unit connected in series, wherein a first input node is located between the seventh switching unit and the eighth switching unit, and the first input node is coupled to the secondary winding of the first transformer;
a second rectification unit, comprising a ninth switching unit and a tenth switching unit connected in series, wherein a second input node is located between the ninth switching unit and the tenth switching unit, and the second input node is coupled to the secondary winding of the second transformer; and
a third rectification unit, comprising an eleventh switching circuit and a twelfth switching circuit connected in series, wherein a third input node is located between the eleventh switching circuit and the twelfth switching circuit, and the third input node is coupled to the secondary winding of the third transformer.

12. The resonant converter as claimed in claim 1, wherein the plurality of resonant inductors and the plurality of transformers are integrated in an integrated magnetic core module.

13. The resonant converter as claimed in claim 12, wherein the integrated magnetic core module comprises an upper cover, a lower cover, a plurality of transformer core columns, a plurality of inductor core columns and a common column, the plurality of transformer core columns, the plurality of inductor core columns and the common column are arranged between the upper cover and the lower cover, and the plurality of transformer core columns and the plurality of inductor core columns are arranged around the common column.

14. The resonant converter as claimed in claim 13, wherein distances between the plurality of transformer core columns and the common column are the same, and distances between the plurality of inductor core columns and the common column are the same.

15. The resonant converter as claimed in claim 13, wherein a cross-sectional area of the plurality of transformer core columns is the same as a cross-sectional area of the common column.

16. The resonant converter as claimed in claim 13, wherein the cross-sectional areas of the plurality of transformer core columns are equal.

17. The resonant converter as claimed in claim 13, wherein distances between the plurality of transformer core columns are equal.

18. The resonant converter as claimed in claim 13, wherein the cross-sectional areas of the plurality of inductor core columns are equal.

19. The resonant converter as claimed in claim 13, wherein distances between the plurality of inductor core columns are equal.

20. The resonant converter as claimed in claim 13, wherein a cross-sectional area of the plurality of transformer core columns is greater than a cross-sectional area of the plurality of inductor core columns.

21. The resonant converter as claimed in claim 13, wherein air gaps of the plurality of inductor core columns are greater than air gaps of the plurality of transformer core columns.

22. The resonant converter as claimed in claim 13, wherein a winding direction of the inductor coils of the plurality of resonant inductors and a winding direction of coils of the plurality of transformers are the same or different.

23. The resonant converter as claimed in claim 13, wherein the plurality of transformer core columns and the plurality of inductor core columns are arranged alternately.

24. The resonant converter as claimed in claim 23, wherein the integrated magnetic core module includes a first resonant inductor, a second resonant inductor, a third resonant inductor, a first transformer, a second transformer and a third transformer, the second resonant inductor is located between the first transformer and the second transformer, the third resonant inductor is located between the second transformer and the third transformer, and the first resonant inductor is located between the first transformer and the third transformer.

25. The resonant converter as claimed in claim 23, wherein the integrated magnetic core module includes a first resonant inductor, a second resonant inductor, a third resonant inductor, a first transformer, a second transformer and a third transformer, the first resonant inductor is located between the first transformer and the second transformer, the second resonant inductor is located between the second transformer and the third transformer, and the third resonant inductor is located between the first transformer and the third transformer.
